(19) United States
(12) Patent Application Publication
(10) Pub. No.: US 2024/0154441 A1
(43) Pub. Date: May 9, 2024

(54) BATTERY CHARGING CURRENT CONTROL DEVICE

(71) Applicant: Wenzhou Qiujie Technology Co., Ltd, Wenzhou (CN)

(72) Inventors: Jianfeng Yang, Wenzhou (CN); Fangguo Zhong, Wenzhou (CN); Lei Chen, Wenzhou (CN)

(21) Appl. No.: 18/174,579

(22) Filed: Feb. 24, 2023

(30) Foreign Application Priority Data
Nov. 9, 2022 (CN) 202211399062.5

(51) Int. Cl. H02J 7/00

(52) U.S. Cl. CPC H02J 7/00711; H02J 7/0048; H02J 7/00714; H02J 7/007182; H02J 7/00032

(57) ABSTRACT

The present disclosure provides a battery charging current control device. The battery charging current control device comprises an H-bridge circuit, a sampling circuit, a control circuit and a pulse width modulation circuit, wherein the H-bridge circuit is respectively connected with an external power supply and a battery and used for transmitting current from the external power supply to the battery for supplying power for the battery; the sampling circuit is connected with the H-bridge circuit and used for collecting an output current and an output voltage of the H-bridge circuit to obtain a current analog signal and a voltage analog signal; the control circuit is connected with the sampling circuit and used for generating a control signal according to the current analog signal, the voltage analog signal and the capacity of the battery; and the pulse width modulation circuit is respectively connected with the control circuit.

### CROSS-REFERENCE TO RELATED APPLICATION

This patent application claims the benefit and priority of Chinese Patent Application No. 202211399062.5, filed with the China National Intellectual Property Administration on Nov. 9, 2022, the disclosure of which is incorporated by reference herein in its entirety as part of the present application.

### TECHNICAL FIELD

The present disclosure relates to the field of battery charging, in particular to a battery charging current control device.

### BACKGROUND

Along with the development of new energy theory, the government strongly supports green travel, and the electric transportation industry has been developed rapidly. The endurance power and charging speed of the battery are important considerations for most users to choose electric travel. The endurance of the battery is closely related to the battery capacity, and at the same charging speed, a larger battery capacity needs to be supported by a control circuit capable of supporting higher current charging.

Therefore, a control device is urgently needed to control the battery charging current.

### SUMMARY

The present disclosure aims to provide a battery charging current control device. The battery charging current can be controlled, so that the charging efficiency is improved.

In order to achieve the-mentioned purpose, the present disclosure provides the following scheme.

The battery charging current control device comprises:
an H-bridge circuit, the H-bridge circuit being respectively connected with an external power supply and a battery and used for transmitting current from the external power supply to the battery for supplying power for the battery;
a sampling circuit, the sampling circuit being connected with the H-bridge circuit and used for collecting an output current and an output voltage of the H-bridge circuit to obtain a current analog signal and a voltage analog signal;
a control circuit, the control circuit being connected with the sampling circuit and used for generating a control signal according to the current analog signal, the voltage analog signal and the capacity of the battery; and
a pulse width modulation circuit, the pulse width modulation circuit being respectively connected with the control circuit and the H-bridge circuit and used for performing pulse width modulation on the H-bridge circuit according to the control signal to control an output current of the H-bridge circuit.
optionally, the control circuit is further used for converting the current analog signal into a current value and converting the voltage analog signal into a voltage value; and
the battery charging current control device further comprises:
a communication circuit, the communication circuit being connected with the control circuit and used for sending the current value and the voltage value to an upper computer to be displayed.

Optionally, the communication circuit is an MAX13487 chip.

Optionally, the battery charging current control device further comprises:
a power supply circuit, the power supply circuit being respectively connected with the external power supply, the sampling circuit, the control circuit and the pulse width modulation circuit and used for supplying power for the sampling circuit, the control circuit and the pulse width modulation circuit.

Optionally, the power supply circuit further comprises:
a rectifier filter sub-circuit, the rectifier filter sub-circuit being connected with the external power supply and used for rectifying and filtering the direct-current voltage of the external power supply to obtain a filter current;
a square wave oscillation sub-circuit, the square wave oscillation sub-circuit being connected with the rectifier filter circuit and used for outputting a square wave signal according to the filter current; and
a transformer voltage conversion sub-circuit, the transformer voltage conversion sub-circuit being respectively connected with the square wave oscillation sub-circuit, the sampling circuit, the control circuit and the pulse width modulation circuit and used for respectively supplying power for the sampling circuit, the control circuit and the pulse width modulation circuit based on the square wave signal.

Optionally, the control circuit is further used for providing a reference voltage; and
the sampling circuit comprises:
a current sampling sub-circuit, the current sampling sub-circuit being respectively connected with the negative electrode at the output end of the H-bridge circuit and the control circuit and used for collecting the output current of the H-bridge circuit and determining the current analog signal based on the reference voltage and the output current; and
the voltage sampling sub-circuit, the voltage sampling sub-circuit being respectively connected with the positive electrode at the output end of the H-bridge circuit and the control circuit and used for collecting the output voltage of the H-bridge circuit to obtain the voltage analog signal.

Optionally, the current sampling sub-circuit comprises:
a sampling resistor, one end of the sampling resistor being connected with the negative electrode at the output end of the H-bridge circuit and the other end of the sampling resistor being grounded, and the sampling resistor being used for collecting the output current of the H-bridge circuit; and
an inverting amplifier, the inverting input end of the inverting amplifier being connected between the sampling resistor and the negative electrode at the output end of the H-bridge circuit, and the non-inverting input end and the non-inverting output end of the inverting amplifier being both connected with the control circuit, and the inverting amplifier being used for amplifying the voltage on the sampling resistor based on the reference voltage to obtain the current analog signal.

Optionally, the H-bridge circuit comprises a first power tube, a second power tube, a third power tube, a fourth power tube and an inductor;
the inductor is respectively connected with the source electrode of the first power tube, the source electrode of the second power tube, the drain electrode of the third power tube and the drain electrode of the fourth power tube;
the drain electrode of the first power tube, the drain electrode of the second power tube, the source electrode of the third power tube and the drain electrode of the fourth power tube are all connected with the external power supply; and
the grid electrode of the first power tube, the grid electrode of the second power tube, the grid electrode of the third power tube and the grid electrode of the fourth power tube are all connected with the pulse width modulation circuit.

Optionally, the inductance of the inductor is 30 uH.

Optionally, the pulse width modulation circuit comprises:
a first PWM driving circuit, the first PWM driving circuit being respectively connected with the grid electrode of the first power tube and the grid electrode of the second power tube and used for performing pulse width modulation on the first power tube and the second power tube according to the control signal to control the connected state of the first power tube and the second power tube;
a second PWM driving circuit, the second PWM driving circuit being respectively connected with the grid electrode of the third power tube and the grid electrode of the fourth power tube and used for performing pulse width modulation on the third power tube and the fourth power tube according to the control signal to control the connected state of the third power tube and the fourth power tube;
the first power tube and the fourth power tube are the same in the connected states at the same time;
the second power tube and the third power tube are the same in the connected states at the same time; and
the first power tube and the third power tube are the same in the connected states at the same time.

According to the specific embodiment provided by the present disclosure, the present disclosure has the following technical effects. The output current and the output voltage of the H-bridge circuit are collected by the sampling circuit to obtain the current analog signal and the voltage analog signal. The control circuit generates the control signal according to the current analog signal, the voltage analog signal and the capacity of the battery. The pulse width modulation circuit performs pulse width modulation on the H-bridge circuit according to the control signal to control the output current of the H-bridge circuit, and then the charging current is correspondingly adjusted according to the capacity of the battery, so that the charging efficiency is improved.

### BRIEF DESCRIPTION OF THE DRAWINGS

To describe the technical scheme in the embodiments of the present disclosure or in the prior art more clearly, the following briefly introduces the attached figures required for describing the embodiments. Apparently, the attached figures in the following description show merely some embodiments of the present disclosure, and those skilled in the art may still derive other attached figures from these attached figures without creative efforts.

FIG. 1 is a schematic diagram of a battery charging current control device in the present disclosure.

FIG. 2 is a schematic diagram of an H-bridge circuit.

FIG. 3 is a schematic diagram of a current sampling sub-circuit.

FIG. 4 is a schematic diagram of a voltage sampling sub-circuit.

FIG. 5 is a schematic diagram of a communication circuit.

FIG. 6 is a schematic diagram of a rectifier filter sub-circuit.

FIG. 7 is a schematic diagram of a square wave oscillation sub-circuit and a transformer voltage conversion sub-circuit.

### REFERENCE SIGNS

1, power supply circuit; 11, rectifier filter sub-circuit; 12, square wave oscillation sub-circuit; 13, transformer voltage conversion sub-circuit; 2, sampling circuit; 21, current sampling sub-circuit; 22, voltage sampling sub-circuit; 3, pulse width modulation circuit; 31, first PWM driving circuit; 32, second PWM driving circuit; 4, H-bridge circuit; 5, communication circuit; and 6, control circuit.

### DETAILED DESCRIPTION OF THE EMBODIMENTS

The following clearly and completely describes the technical scheme in the embodiments of the present disclosure with reference to the attached figures in the embodiments of the present disclosure. Apparently, the described embodiments are merely a part rather than all of the embodiments of the present disclosure. Based on the embodiment in the present disclosure, all other embodiments obtained by the ordinary technical staff in the art under the premise of without contributing creative labor belong to the scope protected by the present disclosure.

The present disclosure aims to provide a battery charging current control device which supports high-current battery charging and has a communication function. The output current can be freely set by the pulse width modulation circuit and the H-bridge circuit, and the current output of 0-20 A can be realized. The battery charging current control device is suitable for all kinds of batteries requiring high-current charging, and the applicability of the charging current control device is improved.

To make the foregoing objective, features and advantages of the present disclosure clearer and more comprehensible, the present disclosure is further described in detail below with reference to the attached figures and specific embodiments.

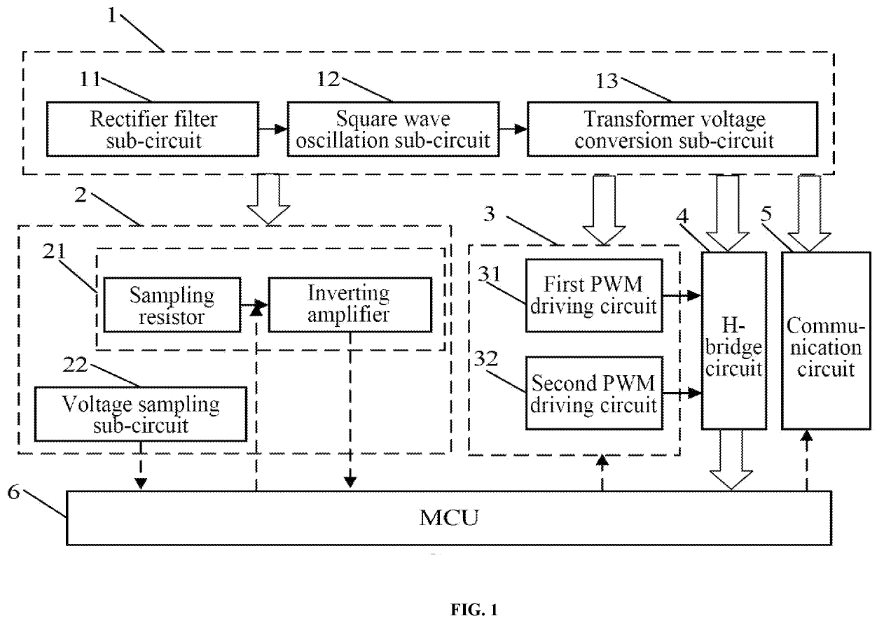

As shown in FIG. 1, the battery charging current control device in the present disclosure comprises an H-bridge circuit 4, a sampling circuit 2, a control circuit 6 and a pulse width modulation circuit 3.

Wherein, the H-bridge circuit 4 is respectively connected with an external power supply and a battery and used for transmitting current from the external power supply to the battery for supplying power for the battery.

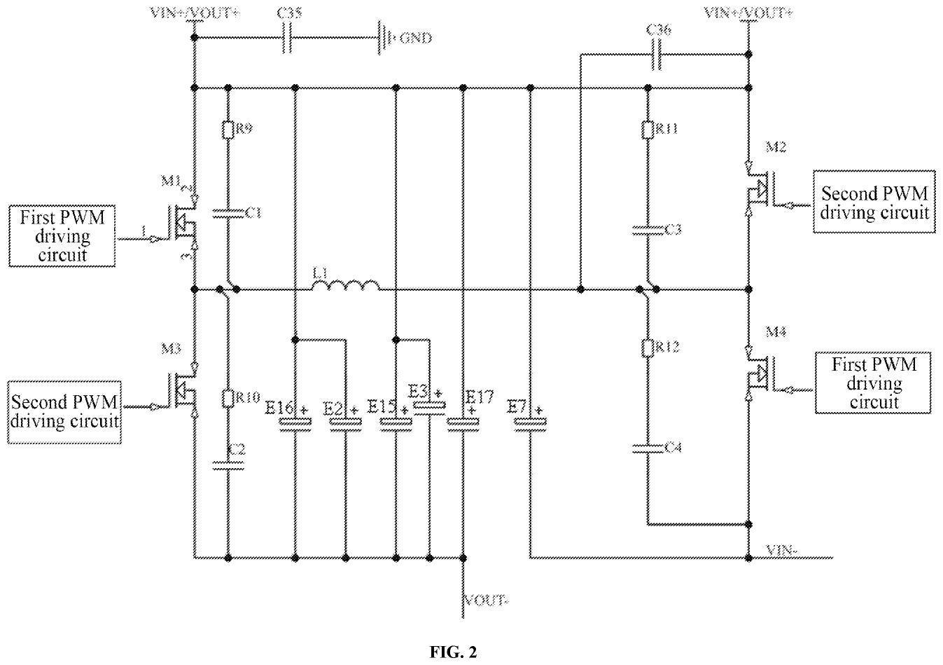

Specifically, as shown in FIG. 2, the H-bridge circuit 4 comprises a first power tube M1, a second power tube M2, a third power tube M3, a fourth power tube M4 and an inductor L1. In the embodiment, the specification of the inductor is 30 uH/60 A. The first power tube M1, the second power tube M2, the third power tube M3 and the fourth power tube M4 are all N-channel MOS tubes.

The inductor L1 is respectively connected with the source electrode of the first power tube M1, the source electrode of the second power tube M2, the drain electrode of the third power tube M3 and the drain electrode of the fourth power tube M4.

the drain electrode of the first power tube M1, the drain electrode of the second power tube M2, the source electrode of the third power tube M3 and the drain electrode of the fourth power tube M4 are all connected with the external power supply.

The grid electrode of the first power tube M1, the grid electrode of the second power tube M2, the grid electrode of the third power tube M3 and the grid electrode of the fourth power tube M4 are all connected with the pulse width modulation circuit 3.

The H-bridge circuit 4 further comprises a plurality of capacitors (C1, C2, C3, C4, C35, C36), a plurality of resistors (R9, R10, R11, R12) and a plurality of electrolytic capacitors (E2, E3, E7, E15, E16, E17). The resistor R9 and the capacitor C1 are connected with the first power tube M1 in parallel after being connected in series. The resistor R11 and the capacitor C3 are connected with the second power tube M2 in parallel after being connected in series. The resistor R10 and the capacitor C2 are connected with the third power tube M3 in parallel after being connected in series. The resistor R12 and the capacitor C4 are connected with the fourth power tube C4 in parallel after being connected in series. The connected relation of the parts is as shown in FIG. 2.

In the H-bridge circuit 4, a pair of NMOS tubes in diagonal relation are in a group, that is, the first power tube M1 and the fourth power tube M4 are in a group, and the second power tube M2 and the third power tube M3 are in a group. The grid voltages of the two groups of power tubes are respectively controlled by the two circuits of the pulse width modulation circuit 3. The power tubes in each group are turned on and off at the same time when the circuit is working, and the power tubes between groups are never connected at the same time when the circuit is working.

The sampling circuit 2 is connected with the H-bridge circuit 4 and used for collecting an output current and an output voltage of the H-bridge circuit 4 to obtain a current analog signal and a voltage analog signal.

Specifically, the control circuit 6 is further used for providing a reference voltage. The sampling circuit 2 comprises a current sampling sub-circuit 21 and a voltage sampling sub-circuit 22.

The current sampling sub-circuit 21 is respectively connected with the negative electrode VOUT− at the output end of the H-bridge circuit 4 and the control circuit 6 and used for collecting the output current of the H-bridge circuit 4 and determining the current analog signal based on the reference voltage and the output current.

In the embodiment, the current sampling sub-circuit 21 comprises a sampling resistor RS1 and an inverting amplifier U7.

One end of the sampling resistor RS1 is connected with the negative electrode VOUT− at the output end of the H-bridge circuit 4 and the other end of the sampling resistor RS1 is grounded. The sampling resistor RS1 is used for collecting the output current of the H-bridge circuit 4.

The inverting input end of the inverting amplifier U7 is connected between the sampling resistor and the negative electrode at the output end of the H-bridge circuit 4, and the non-inverting input end and the non-inverting output end of the inverting amplifier U7 are both connected with the control circuit 6. The inverting amplifier U7 is used for amplifying the voltage on the sampling resistor RS1 based on the reference voltage to obtain the current analog signal.

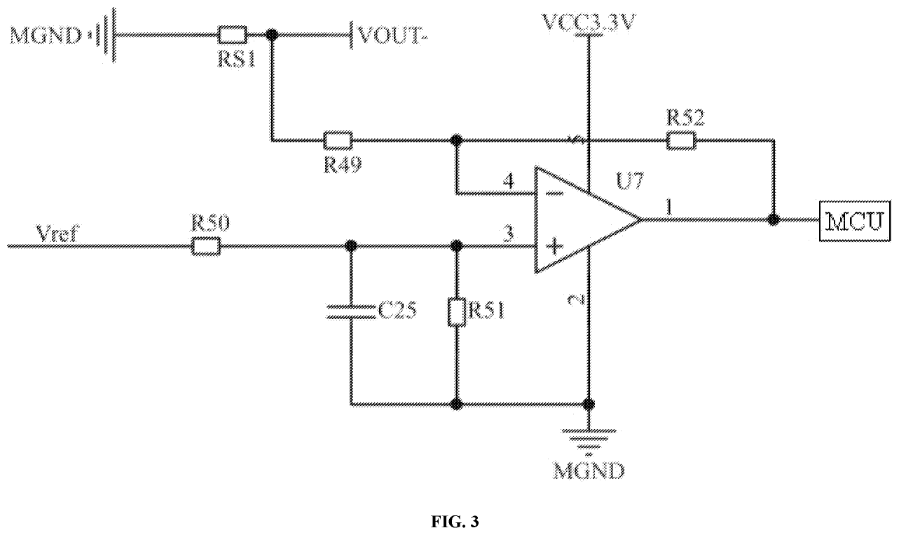

Further, as shown in FIG. 3, the current sampling sub-circuit 21 further comprises a plurality of resistors (R49, R50, R51, R52) and a capacitor C25.

In the realization mode of current sampling, the sampling resistor RS1 is connected between the negative electrode VOUT− at the output end of the circuit and the MGND, the voltage on the sampling resistor RS1 is amplified by 22 times through the inverting amplifier U7, and then the sampling resistor RS1 is connected to the MCU. After analog-to-digital conversion of the MCU, the voltage on the sampling resistor RS1 can be obtained, and then the current flowing through the sampling resistor RS1 can be calculated to complete current sampling. The two input ends of the inverting amplifier U7 are respectively connected with one end of the sampling resistor RS1 and the reference voltage Vref output through the digital-to-analog conversion of the MCU.

The voltage sampling sub-circuit 22 is respectively connected with the positive electrode at the output end of the H-bridge circuit 4 and the control circuit 6 and used for collecting the output voltage of the H-bridge circuit 4 to obtain the voltage analog signal.

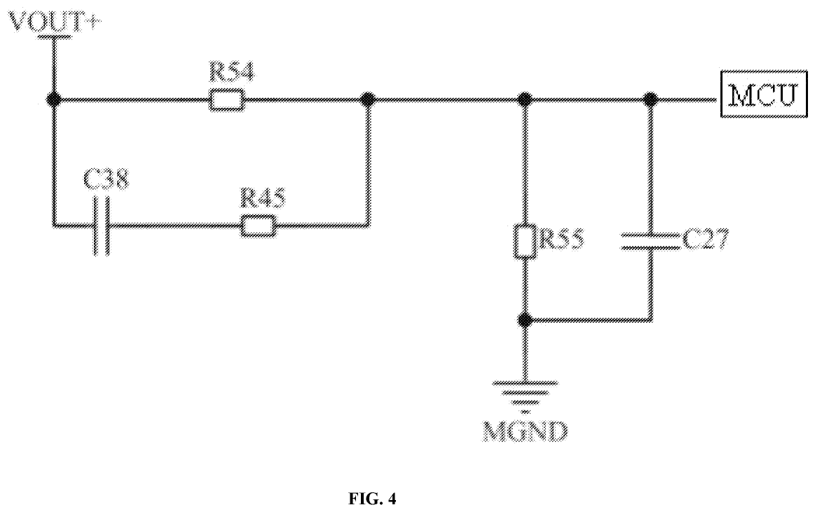

Further, as shown in FIG. 4, the current sampling sub-circuit 22 further comprises three resistors (R45, R54, R55) and two capacitors (C27 and C38). One end of the capacitor R54 is connected to the VOUT+ and the other end of the capacitor R54 is connected to the MCU. The capacitor C38 is connected with the resistor R45 in series and then connected with the capacitor R54 in parallel. One end of the resistor R55 is grounded, and the other end of the resistor R55 is connected between the resistor R54 and the MCU. One end of the capacitor C27 is connected between the resistor R55 and the ground, and the other end of the capacitor C27 is connected to the MCU. The voltage sampling is voltage division sampling by basic resistors. The resistor R54 and the resistor R55 are connected to the output of the circuit for voltage division, the result after voltage division is input into the MCU for analog-to-digital conversion, and then voltage sampling is completed.

The control circuit 6 is connected with the sampling circuit 2 and used for generating a control signal according to the current analog signal, the voltage analog signal and the capacity of the battery. In the embodiment, the control circuit 6 is a microcontroller unit (MCU).

The pulse width modulation circuit 3 is respectively connected with the control circuit 6 and the H-bridge circuit 4 and used for performing pulse width modulation on the H-bridge circuit 4 according to the control signal to control an output current of the H-bridge circuit 4.

Specifically, the pulse width modulation circuit 3 comprises a first PWM driving circuit 31 and a second PWM driving circuit 32.

The first PWM driving circuit 31 is respectively connected with the grid electrode of the first power tube and the grid electrode of the second power tube and used for performing pulse width modulation on the first power tube and the second power tube according to the control signal to control the connected state of the first power tube and the second power tube.

The second PWM driving circuit 32 is respectively connected with the grid electrode of the third power tube and the grid electrode of the fourth power tube and used for performing pulse width modulation on the third power tube and the fourth power tube according to the control signal to control the connected state of the third power tube and the fourth power tube.

The first power tube and the fourth power tube are the same in the connected states at the same time.

The second power tube and the third power tube are the same in the connected states at the same time.

The first power tube and the third power tube are the same in the connected states at the same time.

Further, the control circuit 6 is further used for converting the current analog signal into a current value and converting the voltage analog signal into a voltage value.

In the embodiment, the first PWM driving circuit 31 and the second PWM driving circuit 32 are both ucc21222 chips.

The first power tube M1 and the fourth power tube M4 in the H-bridge circuit 4 are controlled by the first PWM driving circuit 31, and the second power tube M2 and the third power tube M3 are controlled by the second PWM driving circuit 32. The two control circuits 6 cannot be turned on and off at the same time. When the output PWM of the first PWM driving circuit 31 is high, the first power tube M1 and the fourth power tube M4 are turned on, and the current direction on the inductor L1 is from left to right. When the output PWM of the second PWM driving circuit 32 is high, the second power tube M2 and the third power tube M3 are turned on, the current direction on the inductor L1 is reversed, a huge induced electromotive force is generated, and then the voltage of VOUT− is reduced. In the embodiment, the positive electrode VIN+ at the input end of the H-bridge circuit 4 and the positive electrode VOUT+ at the output end of the H-bridge circuit 4 are the same in voltage, and the high voltage output of the circuit mainly depends on reducing the voltage of the negative electrode VOUT− at the output end. In this way, the output current and output voltage of the circuit can be flexibly adjusted, and the output of large current can be realized by using the characteristic of large inductance (30 uH/60 A).

Intelligent charging service is a necessary condition to ensure electric travel. However, due to the lack of intelligent degree of battery charging, users cannot know the charging process in real time during battery charging, resulting in some potential safety hazards. Therefore, the battery charging current control device provided by the present disclosure further comprises a communication circuit 5. The communication circuit 5 is connected with the control circuit 6 and used for sending the current value and the voltage value to an upper computer to be displayed. In the embodiment, the communication circuit 5 is an MAX13487 chip. Through RS-485 communication technology and real-time communication with the upper computer, the voltage and the current of the rechargeable battery are fed back in real time.

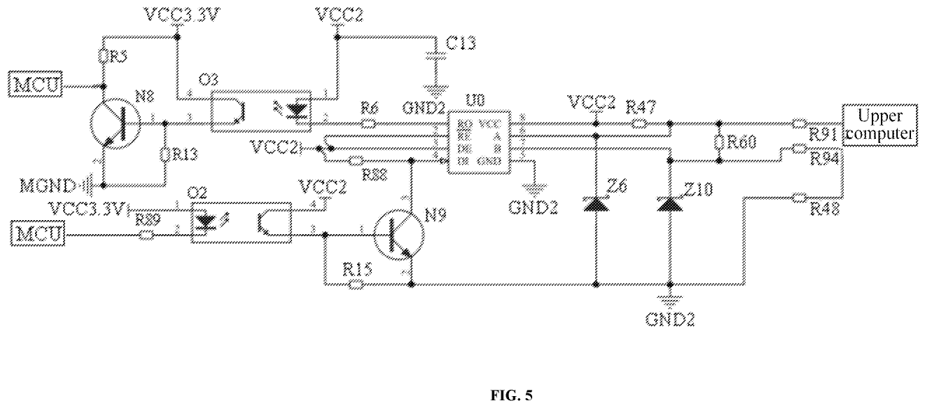

Specifically, as shown in FIG. 5, the communication circuit 5 is in an RS-485 two-wire communication mode to realize multi-point two-way communication. The input end of the communication circuit 5 is connected to the serial output end of the MCU. The MCU can process and send the collected voltage and current data to the communication circuit 5. The output end of the communication circuit 5 is connected to the upper computer for communication. The upper computer can monitor the communication between the communication circuit 5 and the upper computer in real time and obtain the real-time voltage and current.

Furthermore, the battery charging current control device provided by the present disclosure further comprises a power supply circuit 1. The power supply circuit 1 is respectively connected with the external power supply, the sampling circuit 2, the control circuit 6, the pulse width modulation circuit 3 and the communication circuit 5 and used for supplying power for the sampling circuit 2, the control circuit 6, the pulse width modulation circuit 3 and the communication circuit 5.

In the embodiment, the input end of the power supply circuit 1 is connected to 48V direct current, and the output end of the power supply circuit 1 is connected to the first control power supply VCC1, a second control power supply VCC2 and a third control power supply VCC3. Wherein, the first control power supply VCC1 and the third control power supply VCC3 provide internal working voltages for the chips in the subsequent pulse width modulation circuit 3, and the first control power supply VCC1 further stabilizes VCC3.3V through a voltage stabilizing chip LM1117 to provide power supply voltages for the subsequent chips (the MCU, an operational amplifier and the like). The second control power supply VCC2 provides the power supply voltage for the communication circuit 5.

Specifically, the power supply circuit 1 comprises a rectifier filter sub-circuit 11, a square wave oscillation sub-circuit 12 and a transformer voltage conversion sub-circuit 13.

The rectifier filter sub-circuit 11 is connected with the external power supply and used for rectifying and filtering the direct-current voltage of the external power supply to obtain a filter current.

The square wave oscillation sub-circuit 12 is connected with the rectifier filter circuit 11 and used for outputting a square wave signal according to the filter current.

The transformer voltage conversion sub-circuit 13 is respectively connected with the square wave oscillation sub-circuit 12, the sampling circuit 2, the control circuit 3 and the pulse width modulation circuit 5 and used for respectively supplying power for the sampling circuit 2, the control circuit 6, the pulse width modulation circuit 3 and the communication circuit 5 based on the square wave signal. The transformer voltage conversion sub-circuit 13 comprises a transformer and a plurality of diodes.

The input end of the power supply circuit 1 is connected to external direct-current voltage. After the external direct-current voltage is rectified and filtered, power is supplied for the square wave oscillation sub-circuit 12, and the output end of the square wave oscillation sub-circuit 12 is connected to the primary coil of the transformer. Through the electromagnetic induction of the transformer, the voltage is converted into the power supply voltage value required by other circuits.

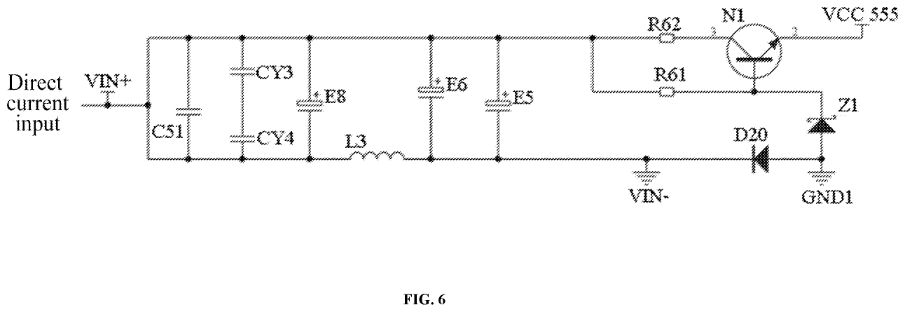

As shown in FIG. 6, the input end of the power supply circuit 1 is connected to a safety capacitor CY3 and a safety capacitor CY4 to suppress common-mode interference. After rectification and filtering, the voltage is used as the power supply voltage VCC_555 of an NE555 chip through a triode N1 and a voltage regulator Z1. Moreover, the power supply circuit 1 further comprises a capacitor C51, three electrolytic capacitors (E5, E6, E8), two resistors (R61 and R62) and a diode D20.

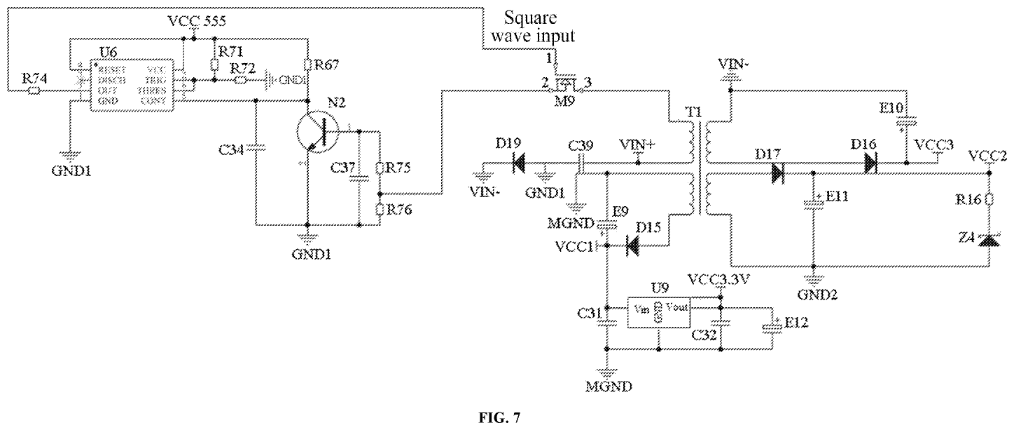

As shown in FIG. 7, through voltage division of the resistor R71 and the resistor R72, the second pin and the sixth pin of the NE555 chip are in the voltage state of 1/3VCC_555. At this time, the output of the chip NE555 is low, and VCC_555 charges the capacitor C34 through the resistor R67. When the capacitor C34 is charged to 1/3VCC_555, the output is high and the power tube M9 is turned on, and then the capacitor C34 is charged through the resistor R75. When the capacitor C34 is charged to 1/3VCC_555, an audion N2 is turned on, and the capacitor C34 is discharged through the audion N2. At this time, the output of the NE555 is low, the power tube M9 is turned off, and the VCC_555 continues to charge the capacitor C34 through the resistor R67. In this way, square wave oscillation can be generated, and the generated square wave oscillation is connected to the primary coil of the transformer, and the transformer converts the voltage into the first control power supply VCC1, the second control power supply VCC2 and the third control power supply VCC3 through electromagnetic induction. In the figure, MGND represents GND of the MCU.

According to the device, the charging current and the charging voltage of the battery can be monitored in real time through the voltage-current sampling and the communication circuit. The output current can be freely set through the pulse width modulation circuit and the H-bridge circuit in a direct-current driving mode, and the current output of 0-20 A can be realized. The battery charging current control device is suitable for all kinds of batteries requiring high-current charging, and the applicability of the charging current control device is improved. In addition, the circuit structure is simple and easy to debug, can be realized by conventional devices, and is easy to realize industrialization.

Several examples are used for illustration of the principles and implementation methods of the present disclosure. The description of the embodiments is used to help illustrate the device and the core principles of the present disclosure; and meanwhile, those skilled in the art can make various modifications in terms of specific embodiments and scope of application in accordance with the teachings of the present disclosure. In conclusion, the content of this specification shall not be construed as a limitation to the present disclosure.

What is claimed is:

1. A battery charging current control device, comprising:
an H-bridge circuit, the H-bridge circuit being respectively connected with an external power supply and a battery and used for transmitting current from the external power supply to the battery for supplying power for the battery;
a sampling circuit, the sampling circuit being connected with the H-bridge circuit and used for collecting an output current and an output voltage of the H-bridge circuit to obtain a current analog signal and a voltage analog signal;
a control circuit, the control circuit being connected with the sampling circuit and used for generating a control signal according to the current analog signal, the voltage analog signal and the capacity of the battery; and
a pulse width modulation circuit, the pulse width modulation circuit being respectively connected with the control circuit and the H-bridge circuit and used for performing pulse width modulation on the H-bridge circuit according to the control signal to control an output current of the H-bridge circuit.

2. The battery charging current control device according to claim 1, wherein the control circuit is further used for converting the current analog signal into a current value and converting the voltage analog signal into a voltage value; and
the battery charging current control device further comprises:
a communication circuit, the communication circuit being connected with the control circuit and used for sending the current value and the voltage value to an upper computer to be displayed.

3. The battery charging current control device according to claim 2, wherein the communication circuit is an MAX13487 chip.

4. The battery charging current control device according to claim 1, further comprising:
a power supply circuit, the power supply circuit being respectively connected with the external power supply, the sampling circuit, the control circuit and the pulse width modulation circuit and used for supplying power for the sampling circuit, the control circuit and the pulse width modulation circuit.

5. The battery charging current control device according to claim 4, wherein the power supply circuit comprises:
a rectifier filter sub-circuit, the rectifier filter sub-circuit being connected with the external power supply and used for rectifying and filtering the direct-current voltage of the external power supply to obtain a filter current;
a square wave oscillation sub-circuit, the square wave oscillation sub-circuit being connected with the rectifier filter circuit and used for outputting a square wave signal according to the filter current; and
a transformer voltage conversion sub-circuit, the transformer voltage conversion sub-circuit being respectively connected with the square wave oscillation sub-circuit, the sampling circuit, the control circuit and the pulse width modulation circuit and used for respectively supplying power for the sampling circuit, the control circuit and the pulse width modulation circuit based on the square wave signal.

6. The battery charging current control device according to claim 1, wherein the control circuit is further used for providing a reference voltage; and
the sampling circuit comprises:
a current sampling sub-circuit, the current sampling sub-circuit being respectively connected with the negative electrode at the output end of the H-bridge circuit and the control circuit and used for collecting the output current of the H-bridge circuit and determining the current analog signal based on the reference voltage and the output current; and
the voltage sampling sub-circuit, the voltage sampling sub-circuit being respectively connected with the positive electrode at the output end of the H-bridge circuit and the control circuit and used for collecting the output voltage of the H-bridge circuit to obtain the voltage analog signal.

7. The battery charging current control device according to claim 6, wherein the current sampling sub-circuit comprises:
a sampling resistor, one end of the sampling resistor being connected with the negative electrode at the output end of the H-bridge circuit and the other end of the sampling resistor being grounded, and the sampling resistor being used for collecting the output current of the H-bridge circuit; and
an inverting amplifier, the inverting input end of the inverting amplifier being connected between the sampling resistor and the negative electrode at the output end of the H-bridge circuit, and the non-inverting input end and the non-inverting output end of the inverting amplifier being both connected with the control circuit, and the inverting amplifier being used for amplifying the voltage on the sampling resistor based on the reference voltage to obtain the current analog signal.

8. The battery charging current control device according to claim 1, wherein the H-bridge circuit comprises a first power tube, a second power tube, a third power tube, a fourth power tube and an inductor;
the inductor is respectively connected with the source electrode of the first power tube, the source electrode of the second power tube, the drain electrode of the third power tube and the drain electrode of the fourth power tube;
the drain electrode of the first power tube, the drain electrode of the second power tube, the source electrode of the third power tube and the drain electrode of the fourth power tube are all connected with the external power supply; and
the grid electrode of the first power tube, the grid electrode of the second power tube, the grid electrode of the third power tube and the grid electrode of the fourth power tube are all connected with the pulse width modulation circuit.

9. The battery charging current control device according to claim 8, wherein the inductance of the inductor is 30 uH.

10. The battery charging current control device according to claim 8, wherein the pulse width modulation circuit comprises:
a first PWM driving circuit, the first PWM driving circuit being respectively connected with the grid electrode of the first power tube and the grid electrode of the second power tube and used for performing pulse width modulation on the first power tube and the second power tube according to the control signal to control the connected state of the first power tube and the second power tube;
a second PWM driving circuit, the second PWM driving circuit being respectively connected with the grid electrode of the third power tube and the grid electrode of the fourth power tube and used for performing pulse width modulation on the third power tube and the fourth power tube according to the control signal to control the connected state of the third power tube and the fourth power tube;
the first power tube and the fourth power tube are the same in the connected states at the same time;
the second power tube and the third power tube are the same in the connected states at the same time; and
the first power tube and the third power tube are the same in the connected states at the same time.
